(19) United States
(12) Patent Application Publication
(10) Pub. No.: US 2017/0103177 A1
(43) Pub. Date: Apr. 13, 2017

(54) PHYSICIAN COMMUNICATION SYSTEMS AND METHODS

(71) Applicant: Christus Health, Irving, TX (US)

(72) Inventors: Daniel Charles Iliff, Keller, TX (US); Paru Sanjaykumar Patel, Grand Prairie, TX (US); Piyush Nilgiri, Coppell, TX (US); Sarah Sharp Upshaw, Coppell, TX (US)

(21) Appl. No.: 15/288,578

(22) Filed: Oct. 7, 2016

Related U.S. Application Data
(60) Provisional application No. 62/239,598, filed on Oct. 9, 2015.

(51) Int. Cl. G06F 19/00; G06F 17/30; H04L 29/08; G06Q 10/06

(52) U.S. Cl. CPC G06F 19/3418; G06F 19/328; G06F 19/327; G06Q 10/06393; G06F 17/30345; H04L 67/306

(57) ABSTRACT

Systems and methods for communicating with physicians are described. Such systems and methods may include performing the following on a real-time basis via a single application at a client computer: displaying a personal profile of a physician; sending and receiving communications between the physician and an administration; displaying financial charges and collections associated with work performed by the physician during a specified period of time; displaying historical, current, and projected compensation for the physician based on daily productivity updates; displaying data representative of time away from practice for the physician; displaying geographic locations of the physician's patients; displaying professional business expenses for the physician; displaying quality metrics and patient satisfaction performance data for the physician against other similar physicians; displaying charge-lag, no-show rates, slot times, and clinic schedules for the physician; and displaying a resources page comprising links to a plurality of other information sources for the physician.

### CROSS REFERENCE TO RELATED APPLICATIONS

This application claims priority to U.S. Provisional Patent Application No. 62/239,598 filed Oct. 9, 2015, the disclosure of which is incorporated herein by reference.

### BACKGROUND

In the field of health care providers, a given health care institution may have multiple facilities at various locations, each of which may have unique reporting capabilities. Such health care institutions may also have multiple different information technology platforms across the various facilities (e.g., billing and collecting, benefits, quality, patient satisfaction, compensation, and the like) which provide information via multiple websites or other information sources. As a health system, it is important for the physicians to concentrate on quality of care, patient access, and cost reduction. Physicians can often find themselves spending a lot of their time and/or staff resources searching for data from several, sometimes hard to find, locations in order to validate data provided by the employer and searching for ways to improve compensation and quality. An engaged, knowledgeable physician is an empowered, effective health care partner. Quite often, the intricate data compilation required to have an accurate overview of practice performance is overwhelming to a physician.

Frequently, poor time management and scattered resources lead to additional clinic time and less quality of life. Increased wait times for patients and lack of communication to/from the physician leave a dissatisfied patient, low quality care, and an overworked physician without the requisite resources. Physicians currently pull productivity data manually, add the work relative value units (wRVU) together, and multiply the conversion factors to determine future base and bonus compensation. They also manually track their quality and patient satisfaction metrics, patient visits, collections and charges, while attempting to see as many patients as possible. There is currently not enough staff to report this information monthly, so the physician typically receives a report bi-annually. This delayed reporting presents many challenges that lead to low productivity, low capacity, decreased revenue and higher cost.

It would be a significant advancement in the art to provide systems and methods that provide physicians with a single source of information pertaining to their practices in real time to enhance their productivity, quality, growth, and sustainability.

### SUMMARY

Systems and methods for communicating with physicians are described. Such systems and methods may include performing the following on a real-time basis via a single application at a client computer: displaying a personal profile of a physician; sending and receiving communications between the physician and an administration; displaying financial charges and collections associated with work performed by the physician during a specified period of time; displaying historical, current, and projected compensation for the physician based on daily productivity updates; displaying data representative of time away from practice for the physician; displaying geographic locations of the physician's patients; displaying professional business expenses (PBE) for the physician; displaying quality metrics and patient satisfaction performance data for the physician against other similar physicians; displaying charge-lag, no-show rates, slot times, and clinic schedules for the physician; and displaying a resources page comprising links to a plurality of other information sources for the physician.

In some embodiments, such systems and methods may include performing the following on a real-time basis via a single application at a client computer: accessing a database maintained by a health care administration using a communication portal; displaying a personal profile of a physician; sending and receiving communications between the physician and the health care administration using said communication portal; wherein the physician is a member of a group of physicians managed by the health care administration; wherein the personal profile of the physician is a profile among a plurality of profiles for other physicians included in the group of physicians; displaying geographic locations of the physician's patients and information regarding inbound referring partners among the other physicians and information regarding outbound referral patterns from the physician to facilitate determination of continuity of care for the physician's patients; displaying quality metrics and patient satisfaction performance data for the physician against other similar physicians; receiving daily productivity updates for the physician through the communication portal; displaying financial charges and collections associated with work performed by the physician during a specified period of time; and displaying historical, current, and projected compensation for the physician based on the daily productivity updates.

In some embodiments, a healthcare communication system may include a database maintained by a health care administrator; wherein the database includes a repository of data pertaining to a plurality of practices for a plurality of physicians and patients of the plurality of physicians. The healthcare communication system may further include a computer in communication with the database, the computer programmed to communicate with a plurality of computers through a communication portal and provide information to the plurality of computers to allow each of the plurality of computers to perform the aforementioned client computer functions on a real-time basis.

### BRIEF DESCRIPTION OF THE DRAWINGS

Examples of systems and methods for communication with physicians are shown in the accompanying drawings in which:

FIG. 1 is a schematic diagram of a physician communication system.

FIG. 2 is a screen shot of a physician profile and communication portion of the system of FIG. 1.

FIG. 3 is a screen shot of a financial charges and collections portion of the system of FIG. 1.

FIG. 4 is another screen shot of a financial charges and collections portion of the system of FIG. 1, which demonstrates the ability to view charges and collections by payor mix through a dropdown menu.

FIG. 5 is yet another screen shot of a financial charges and collections portion of the system of FIG. 1, showing that a physician may view year-over-year charges and collections by procedure group.

FIG. 6 is yet another screen shot of a financial charges and collections portion of the system of FIG. 1, which demonstrates convenient management and tracking of CPT code utilization by procedure group.

FIG. 7 is a screen shot of a productivity tracking portion of the system of FIG. 1, which illustrates how a physician can track wRVU trends and patient visits while measuring against national MGMA benchmarks for comparisons. A quick look by payor group allows the physician to know how many wRVUs are generated in each payor category.

FIG. 8 is a screen shot of a compensation calculation portion of the system of FIG. 1, which illustrates how a physician is able to view current 6 or 12 months clinical compensation while viewing their projected compensation based on their real-time productivity. The compensation breakdown shows all compensation components including medical director, on-call, supervision, quality payments, etc. Compensation trend can be viewed over 2 years or other suitable time period.

FIG. 9 is a screen shot of a professional business expense portion of the system of FIG. 1, illustrating how budgeted medical education, travel expenses and status can be tracked throughout the year.

FIG. 10 is a screen shot of a patient geo analytics portion of the system of FIG. 1, which illustrates how a physician can analyze existing patient panel locations to easily view target markets for population health and strategic marketing.

FIG. 11 is a screen shot of a quality performance and patient satisfaction portion of the system of FIG. 1, which illustrates how monthly tracking of physicians' patient satisfaction scores and quality performance metrics allows physicians to actively contribute to clinic improvement.

FIG. 12 is another screen shot of a quality performance portion of the system of FIG. 1, which illustrates how a physician can easily view personal and system quality performance for patient follow-up from hospital discharge. These metrics enable immediate and strategic decision making for clinic process improvement and continuum of care performance.

FIG. 13 is a screen shot of a resources portion of the system of FIG. 1, which illustrates how a physician is able to access key contacts and links related to practice management, human resources, policies, etc. from one convenient page.

FIG. 14 is a screen shot of an instructional aid for the system of FIG. 1, which illustrates a profile page that may be displayed upon login.

FIG. 15 is a screen shot of an instructional aid for the system of FIG. 1, which shows how to create, edit, and/or discard issues.

FIG. 16 is a screen shot of an instructional aid for the system of FIG. 1, which shows a financials tab.

FIG. 17 is a screen shot of an instructional aid for the system of FIG. 1, which shows a productivity tab.

FIG. 18 is a screen shot of an instructional aid for the system of FIG. 1, which shows compensation and expense tabs.

FIG. 19 is a screen shot of an instructional aid for the system of FIG. 1, which shows a resources tab.

### DETAILED DESCRIPTION

The following terms as used herein should be understood to have the indicated meanings unless the context requires otherwise.

When an item is introduced by “a” or “an,” it should be understood to mean one or more of that item.

“Communication” means the transmission of one or more signals from one point to another point. Communication between two objects may be direct, or it may be indirect through one or more intermediate objects. Communication in and among computers, I/O devices and network devices may be accomplished using a variety of protocols. Protocols may include, for example, signaling, error detection and correction, data formatting and address mapping. For example, protocols may be provided according to the seven-layer Open Systems Interconnection model (OSI model), the TCP/IP model, or any other suitable model.

“Comprises” means includes but is not limited to.

“Comprising” means including but not limited to.

“Computer” means any programmable machine capable of executing machine-readable instructions. A computer may include but is not limited to a general purpose computer, mainframe computer, microprocessor, computer server, digital signal processor, personal computer (PC), personal digital assistant (PDA), laptop computer, desktop computer, notebook computer, smartphone (such as Apple's iPhone™, Motorola's Atrix™ 4G, and Research In Motion's Blackberry™ devices, for example), tablet computer, netbook computer, portable computer, portable media player with network communication capabilities (such as Microsoft's Zune HD™ and Apple's iPod Touch™ devices, for example), camera with network communication capability, wearable computer, point of sale device, or a combination thereof. A computer may comprise one or more processors, which may comprise part of a single machine or multiple machines.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“GUI” means graphical user interface.

“Having” means including but not limited to.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

“Program” may comprise any sequence of instructions, such as an algorithm, for example, whether in a form that can be executed by a computer (object code), in a form that can be read by humans (source code), or otherwise. A program may comprise or call one or more data structures and variables. A program may be embodied in hardware, software, firmware, or a combination thereof. A program may be created using any suitable programming language, such as C, C++, Java, Perl, PHP, Ruby, SQL, other languages, and combinations thereof. Computer software may comprise one or more programs and related data. Examples of computer software may include system software (such as operating system software, device drivers and utilities), middleware (such as web servers, data access software and enterprise messaging software), application software (such as databases, video games and media players), firmware (such as software installed on calculators, keyboards and mobile phones), and programming tools (such as debuggers, compilers and text editors).

“Signal” means a detectable physical phenomenon that is capable of conveying information. A signal may include but is not limited to an electrical signal, an electromagnetic signal, an optical signal, an acoustic signal, or a combination thereof.

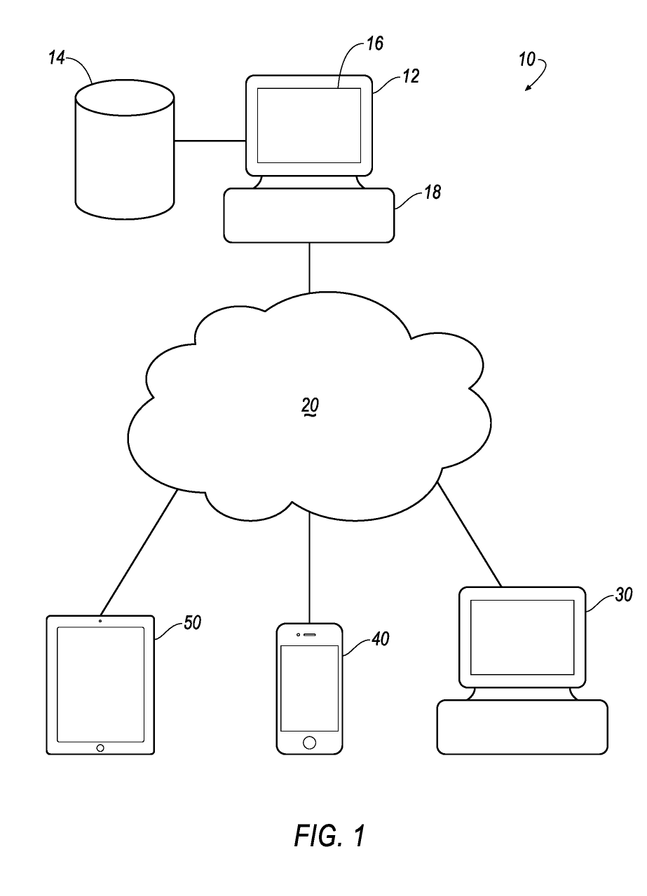

As shown in FIG. 1, a system 10 may include a computer 12 in communication with a memory 14, a display 16, and an I/O device 18. Although only one computer, memory, display, and I/O device are shown in FIG. 1, persons of ordinary skill in the art will understand that more than one of each of those items may be employed if desired. Computer 12 may be programmed with one or more programs on one or more computer readable mediums to carry out the methods described herein. In some embodiments, computer 12 (as well as some or all of the other components, such as memory 14, display 16, and I/O device 18) may all be part of the same machine. Computer 12, which may serve as a server computer, may be in wired or wireless communication with one or more client computers, such as desktop computer 30, smartphone 40, and tablet computer 50, for example, via one or more networks 20. Network 20 may be any suitable communication network, such as the Internet or an intranet network, for example. Physicians and other users of system 10 may operate such client computers in order to access the computer programs and data of computer 12 and memory 14 as described herein.

Memory 14 may serve as a repository of a database containing data pertaining to the practices of a plurality of physicians and their patients. For example, for each physician, such data may include information regarding the name, photograph, identification number, specialty, location, department, hire date, full time equivalent (FTE) status, time away from practice (TAP) allowance, TAP balance, billing rate, time worked, procedures performed on each patient, and the relevant payor associated with each patient and procedure, such as commercial insurance, Medicaid, Medicare, Tricare, and self-pay. Such data may also include the dates, charges, collections, codes (such as CPT codes, for example), wRVU, procedure group (e.g., lab and pathology, E & M, surgery, new sick visits, injection, medicine, and other), and patient satisfaction data associated with each procedure. Of course, any other relevant data pertaining to each physician and his or her practice may also be included in such database.

Computer 12 and client computers 30, 40, 50 may be programmed with instructions to process such data and format it for display on such client computers, e.g., via one or more GUIs, as described further herein. In some embodiments, a computer software application referred to herein as “MyDashboard” may be pushed to each client computer 30, 40, 50 to facilitate such access to the data. Via such application, each physician may operate such client computer to (1) browse his or her personal profile, communicate with the associated health care administration via the communication portal, review his or her financial charges and collections and compensation, and access other resources; (2) manage his or her vacation days, sick days, and continuing medical education (CME) days by immediate access to real-time accumulation and utilization information; (3) view his or her historical, current, and projected compensation based on daily productivity updates; (4) view a resources tab for an accumulation of applicable websites, policies, forms, FAQ, and administration contact information; (5) easily view geographic locations where his or her patients are coming from for strategic marketing and future population health management; (6) quickly compare his or her personal quality metrics and patient satisfaction performance against other physicians in the clinic or community; and (7) view charge-lag, no-show rates, slot times and daily/weekly/monthly clinic schedules to improve patient access.

As persons of ordinary skill in the art will appreciate, with all the needed resources accessible in one place through the “MyDashboard” application, the physician can quickly view and easily navigate critical analysis and be constantly updated to make informed decisions that may have taken several hours without such application. The physicians can see how their increased productivity influences increased compensation and understand what steps to take to manage a successful practice. They can monitor their own slot-times, have heightened awareness of no-show rates, manage marketing strategies, and continuously improve patient satisfaction and quality measures. This enables the physicians to provide better quality of care, enhance clinic access, and reduce cost while not requiring additional staffing resources.

The “MyDashboard” portal may be designed to provide the physician with more autonomy and the ability to quickly make informed decisions due to critical and timely data access. The portal may increase transparency and communication, which builds trust when office-based physicians can often feel removed from the health system. “MyDashboard” may allow the physicians to see where their patients are coming from to further influence the health of their community and increase patient awareness of physician services at the clinic. The mobile device functionality of client computers such as smartphone 40 and tablet 50, for example, may provide each physician the ability to monitor production, compensation adjustments, quality metrics, and patient satisfaction while communicating directly with administration through the communication portal while on the go. Capturing continuously updated intra-group referrals may give the physicians confidence in knowing they are part of a larger group of physicians improving continuity of care.

In some embodiments, implementation of the solution may be a simple push of the “MyDashboard” portal onto the physician's desktop computer or download of the app on an iPad or Android device, for example. The physician may be responsible for very little work to get this implemented. The portal may be designed to provide the aforementioned data on-demand without the physicians having to query the information themselves. The portal may be very intuitive in that it may require little instruction or detailed business knowledge to be able to use and understand the contents. In some embodiments, no additional passwords are necessary to begin using the portal.

Such a solution may help a medical practice meet their business goals. Quality of care may be improved by use of real-time status updates on metrics to allow immediate action if quality and patient satisfaction is declining. Cost reduction may be realized in that the portal may limit the need for additional reporting from staff and physicians. Cost reduction may also be seen from strategic marketing campaigns through the geo tracking functionality. Time-consuming manual calculations of productivity and compensation are eliminated as those calculations may be completed through system 10 as described herein. Physicians may have increased awareness of current charge-lag, no-show rates, slot-times, and scheduling, which may allow for further cost reduction and increased revenue. The application may yield time savings and decreased administrative burden because the physicians may concentrate more on the patients and less time on time-consuming reports, calculations, and meetings. The application may also facilitate physician networking and referral patterns for continuity of care. The physicians may see who their inbound referring partners are and their outbound referral patterns to determine continuity of care.

In some embodiments, the “MyDashboard” solution may improve the experience of physicians, staff, and patients during patient visits by daily tracking of key quality measures helping to identify areas of opportunity to improve patient care and outcomes. Such a dashboard that displays up-to-date metric status on the client computers 30, 40, 50 may allow monitoring of the impact in the office flow, new procedure implementation, or need for additional educational tools. Being able to plot these quality improvements in coordination with patient satisfaction or collections by CPT code daily on the client computers 30, 40, 50 may help guide physicians to make informed decisions for their practices and the patients. In some embodiments, benefits of the dashboard may be quantified by the decrease in need for administrative support, the increase in physician and clinic productivity, improvements in patient satisfaction results, reduced time spent by the physicians and staff to research and monitor various data sources and reports, and increased revenue. In some embodiments, the “MyDashboard” solution may display on client computers 30, 40, 50 for each physician the amount of PBE available and utilized, the geographical location of the patient population for targeted marketing, collections and charge data graphed against prior year by month, quality measures reports, revenue by procedure code, and managing of vacation days.

Prior to system 10 as described herein, all this critical practice information was generally fragmented in multiple different Excel™ spreadsheets or vendor platforms. A dashboard as described herein, however, may automate simplified real-time reporting of all such data in one location. The dashboard may also readily encourage responsible time management by physicians in helping them to decide when they may need to open their appointment schedules to allow for more productivity or plan vacations. It thus may become an incentive tool rather than a punitive measurement.

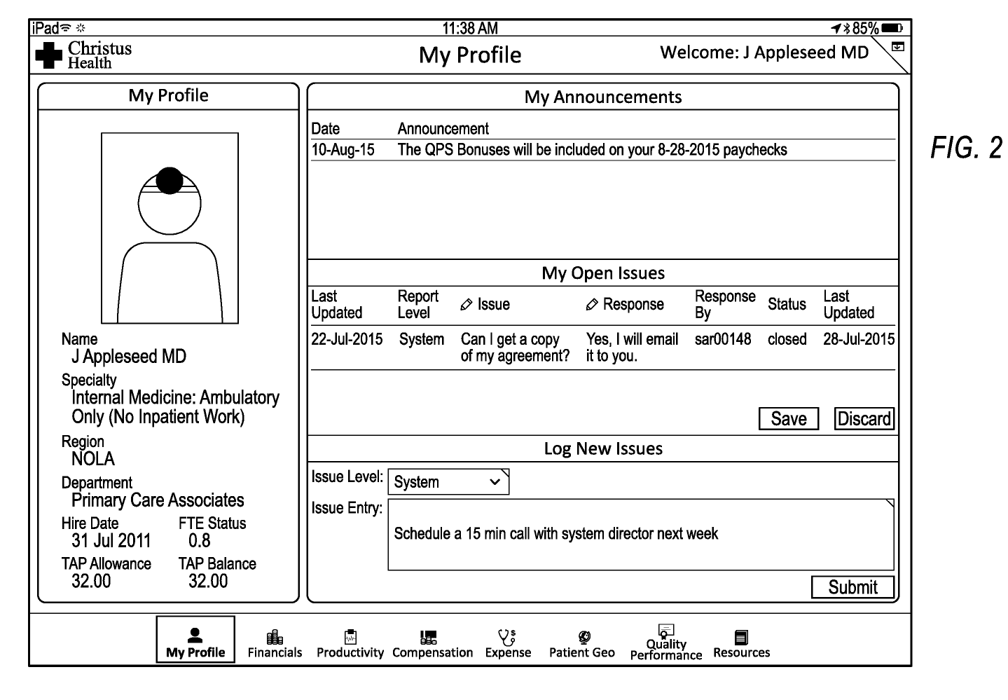

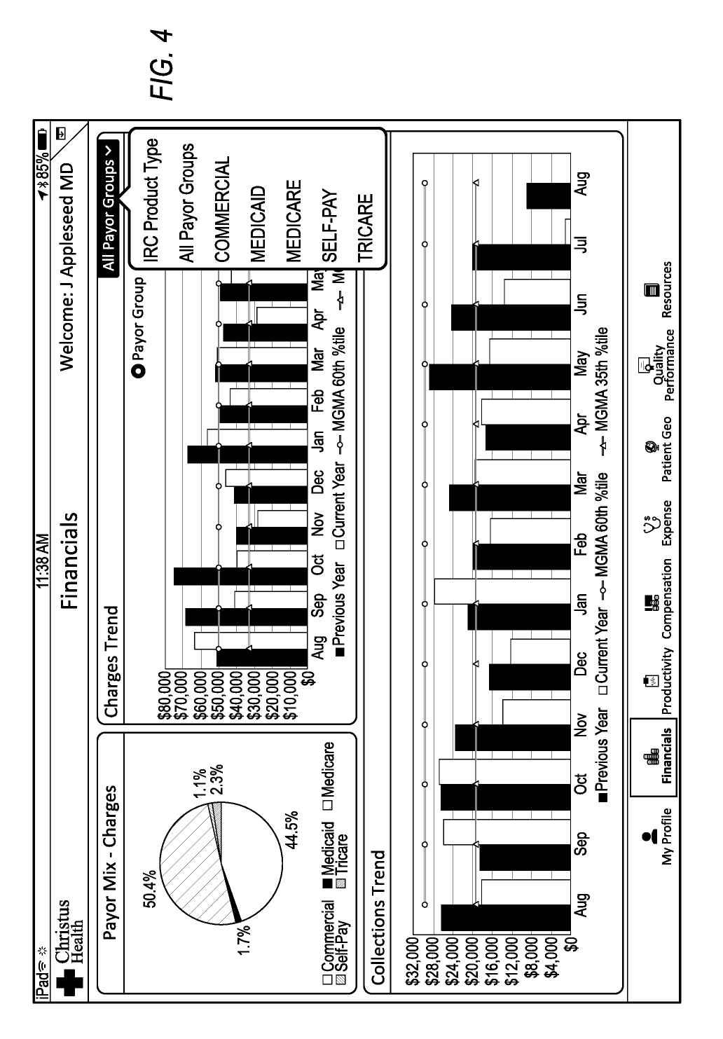

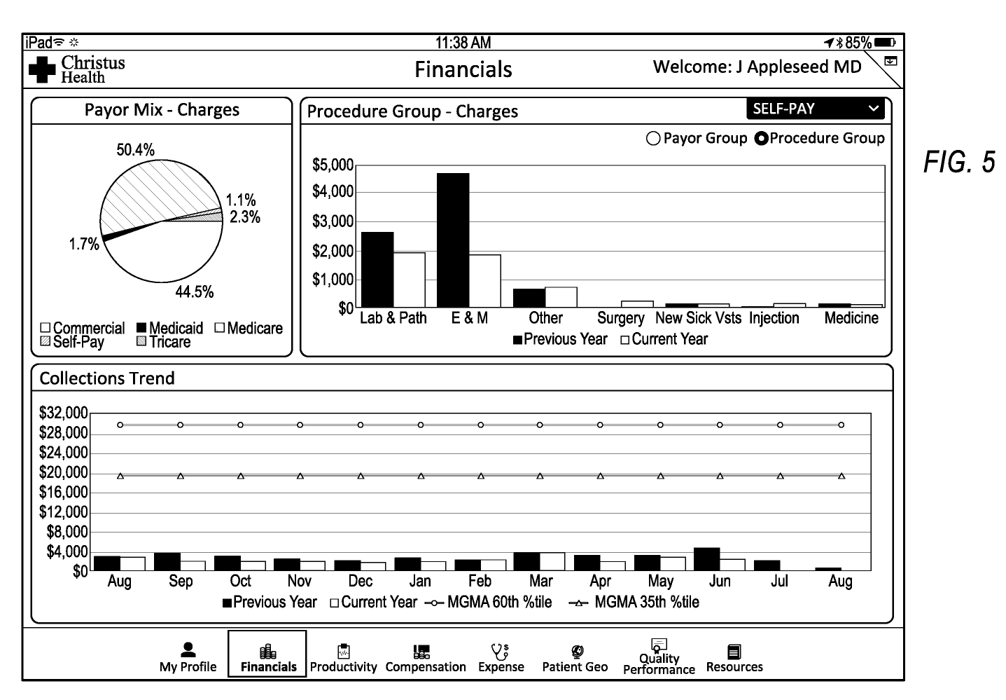

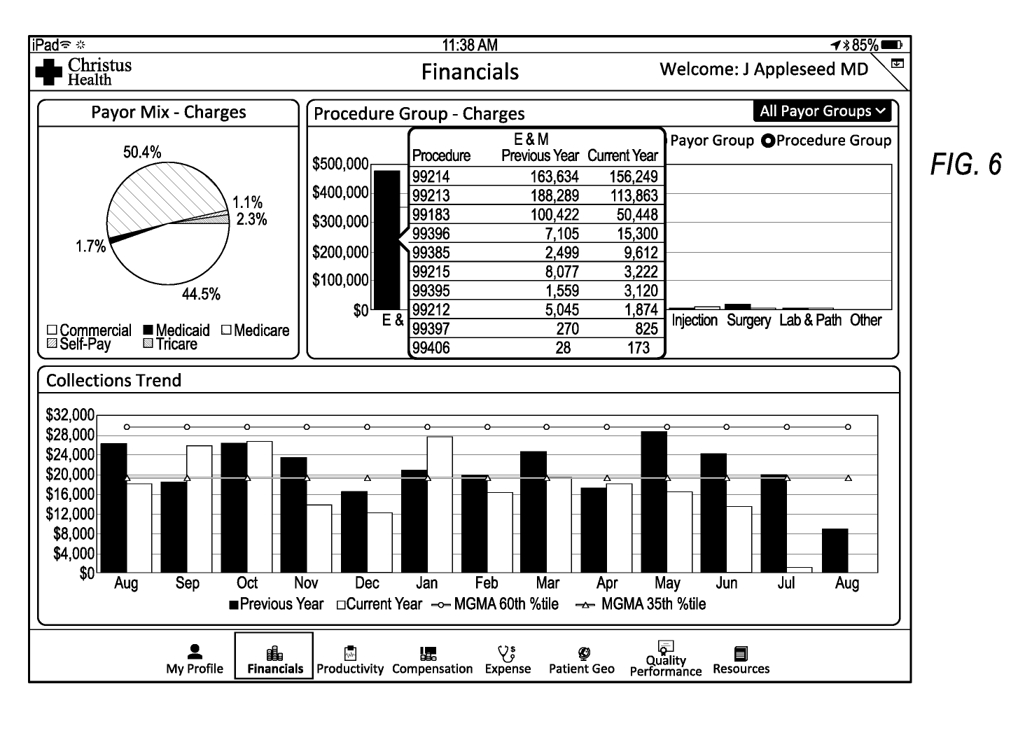

Examples of screen shots for such a “MyDashboard” application are shown in FIGS. 2-13. As shown in FIG. 2, each physician may have a profile and communication page to easily communicate questions, concerns, comments, and announcements between the physician and the administration while continuously being updated on the progress towards resolution. The physician is also able to track and manage time away from practice throughout the year. The physician may also select icons to view information regarding financials, productivity, compensation, expenses, patient geography, quality performance, and other resources.

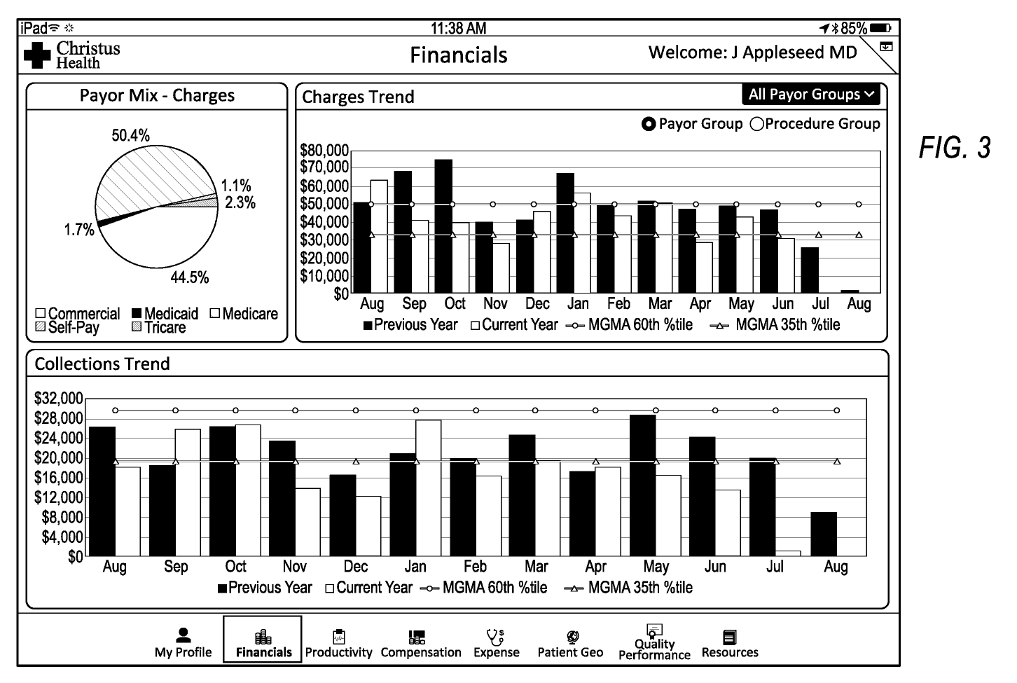

As shown in FIGS. 3-6, each physician may quickly see year-over-year and month-by-month financial trends for charges and collections pertaining to his or her medical services. Medical Group Management Association (MGMA) benchmarks for the 35^{th}%tile and 60^{th}%tile of such data may also be displayed with the particular physician's data to enable each physician to compare himself or herself to like-specialists on a national or other regional level. Such data may be displayed for each payor or for all payors collectively. Additionally, such data may be displayed for each group or type of procedure or for all procedures collectively and may provide convenient management and tracking of CPT code utilization by procedure group.

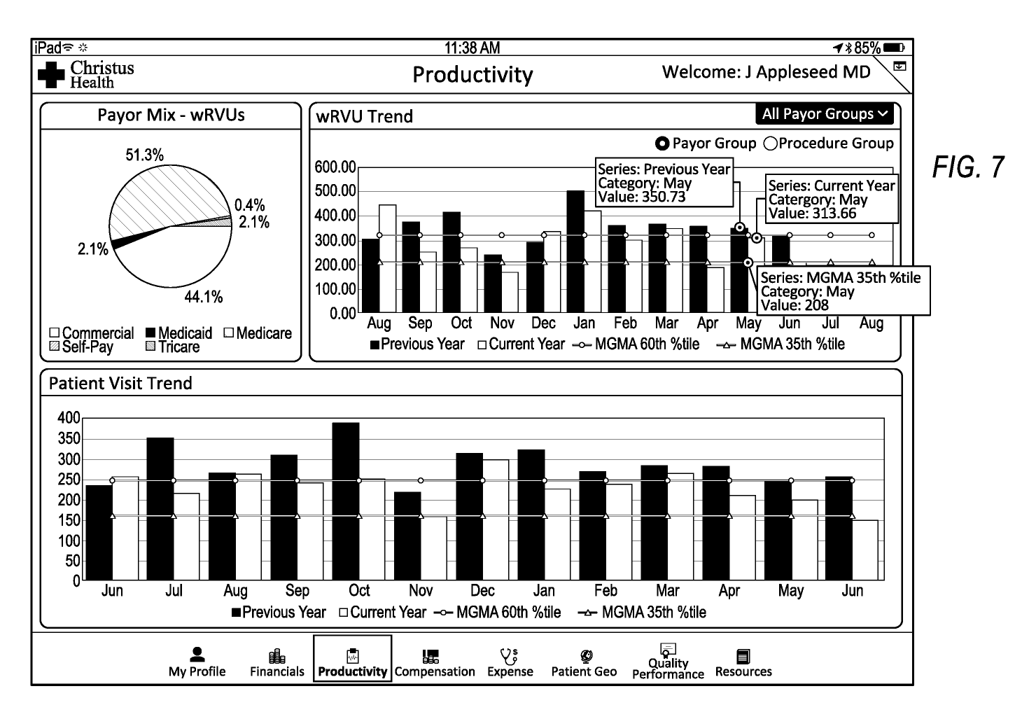

As shown in FIG. 7, each physician may view his or her patient visits and wRVU data month-by-month and year-over-year. Each physician may thus track wRVU trends and patient visits while measuring against national MGMA benchmarks for comparisons. Such productivity data may be viewed by payor group or procedure group and may allow the physician to know how many wRVUs are generated in each payor or procedure category.

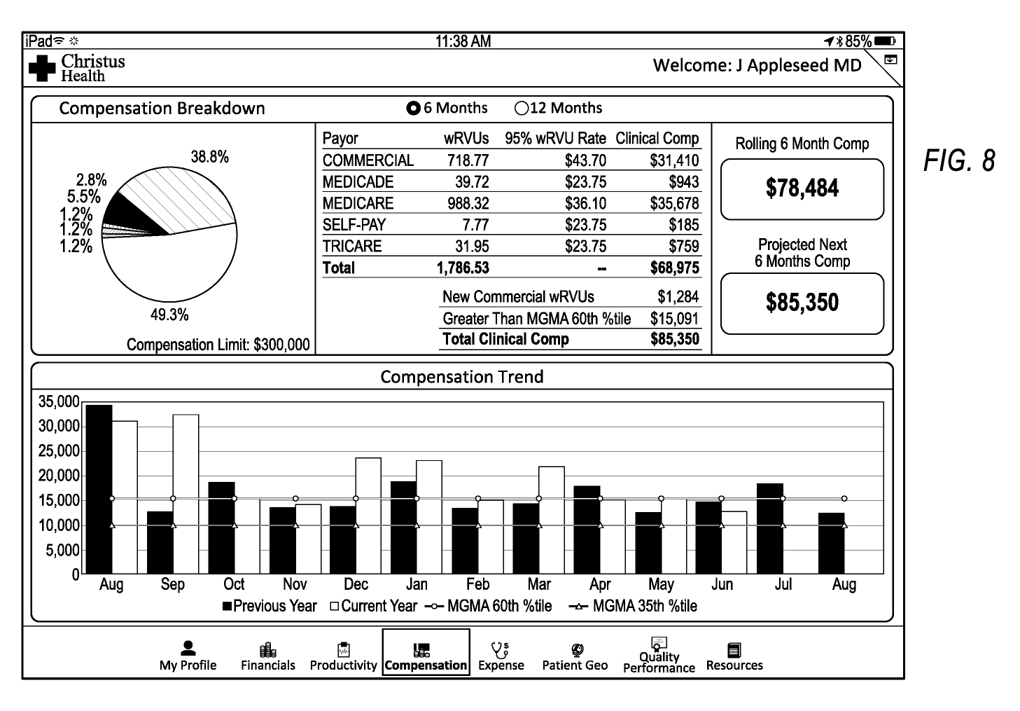

As shown in FIG. 8, each physician may view current 6 or 12 months clinical compensation month-by-month and year-over-year while viewing his or her projected compensation based on real-time productivity data. The compensation breakdown shows all compensation components, including medical director, on-call, supervision, quality payments, and the like, for example. Compensation trends may be viewed over a selected period, such as 2 years or other suitable period, for example.

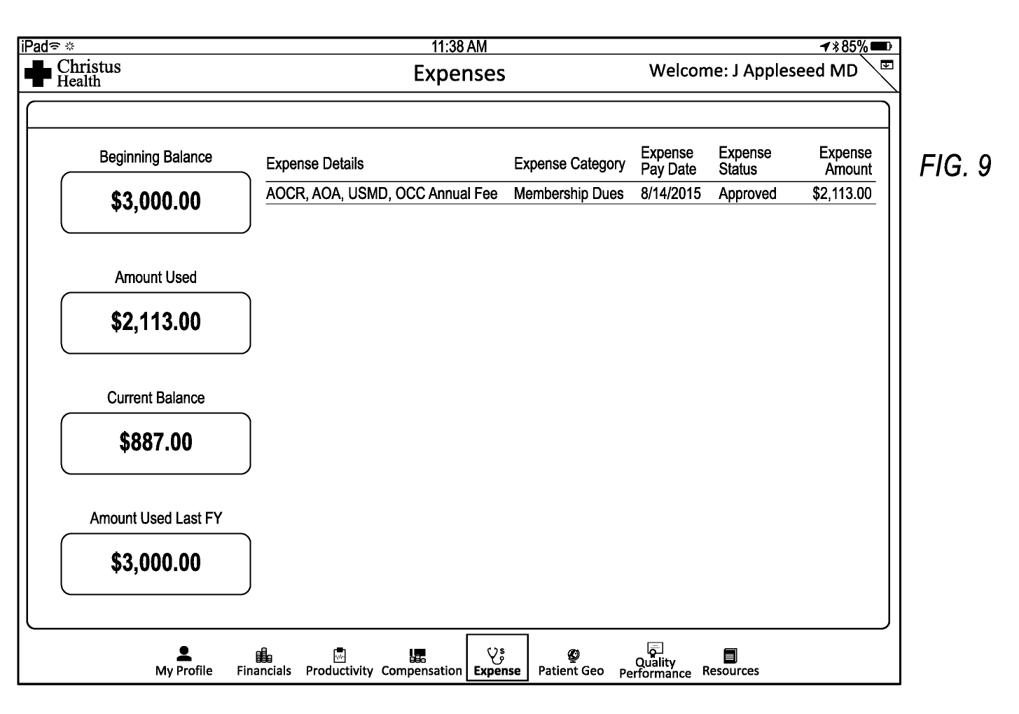

As shown in FIG. 9, each physician may view his or her budgeted professional business expenses to include: medical education, travel, and other expenses, and status versus budget may be tracked throughout the year.

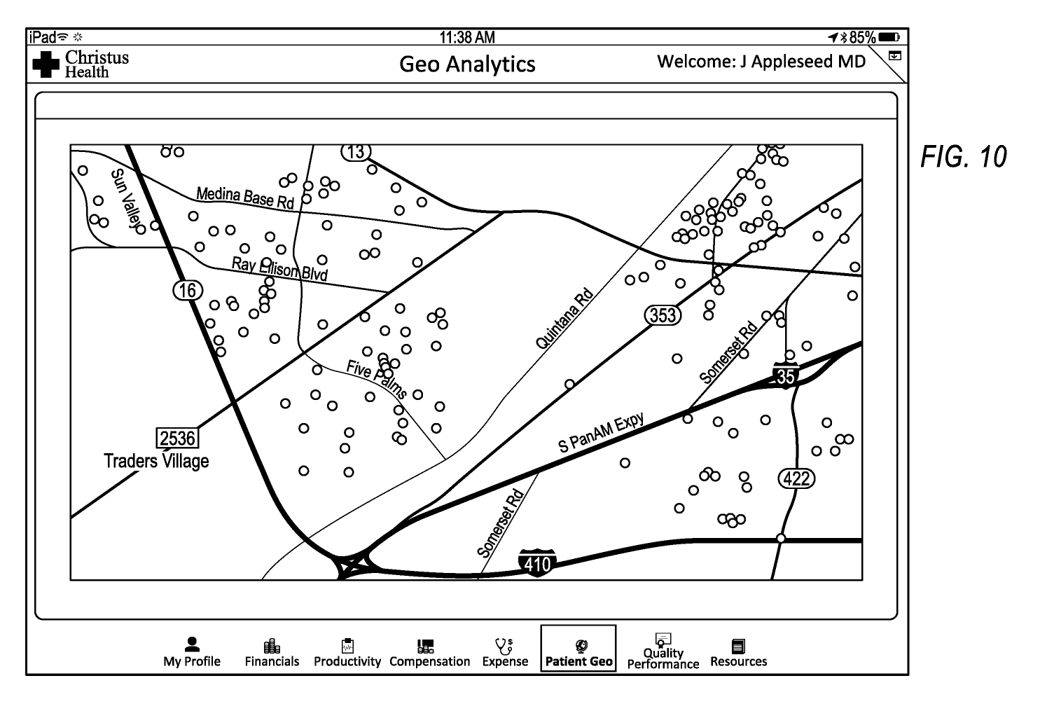

As shown in FIG. 10, each physician may view the geographic locations of his or her patients and thereby easily determine target markets for population health and strategic marketing.

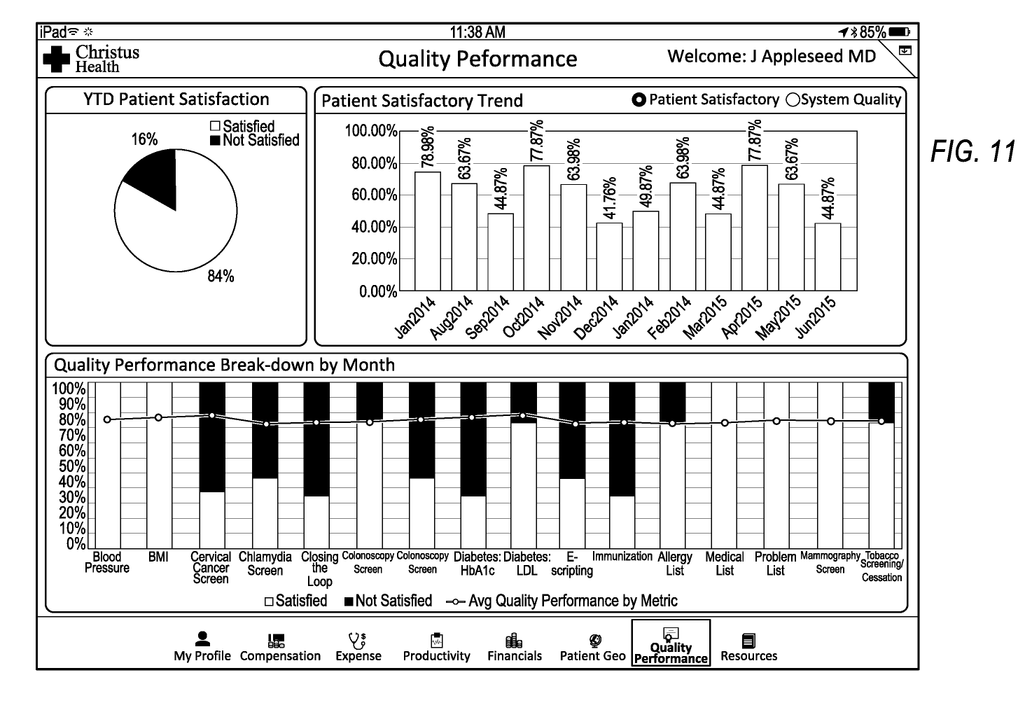

As shown in FIG. 11, each physician may view his or her patient satisfaction scores and quality performance metrics on a monthly or other periodic basis and on a procedure level, which may allow the physician to actively contribute to clinic improvement.

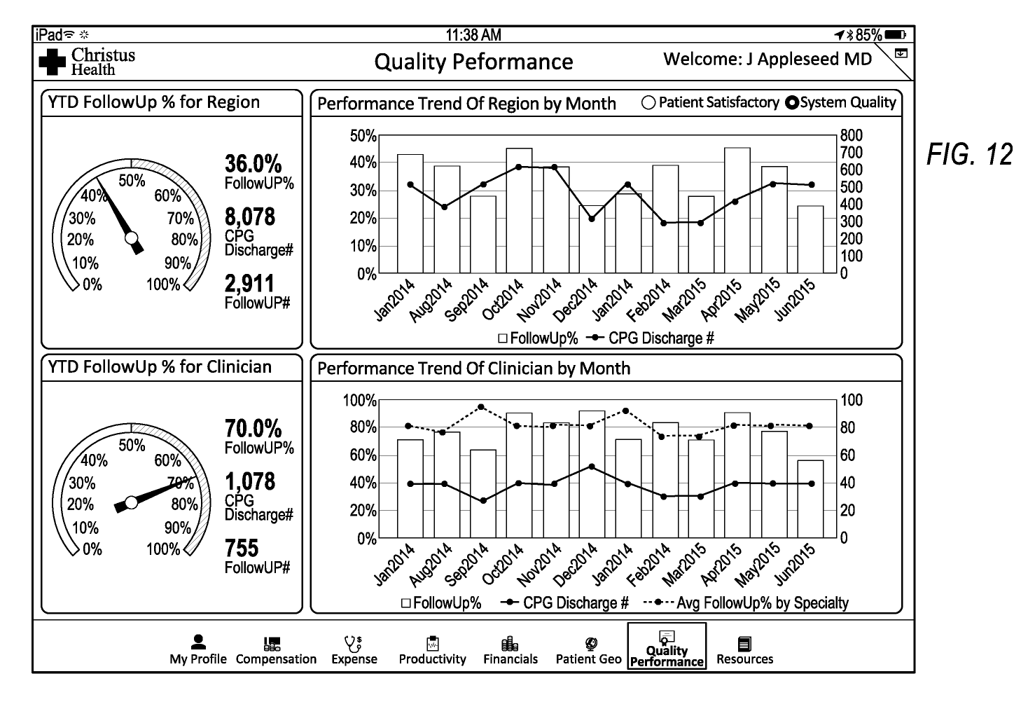

As shown in FIG. 12, each physician may easily view personal and system quality performance for patient follow-up from hospital discharge. These metrics may enable immediate and strategic decision making for clinic process improvement and continuum of care performance.

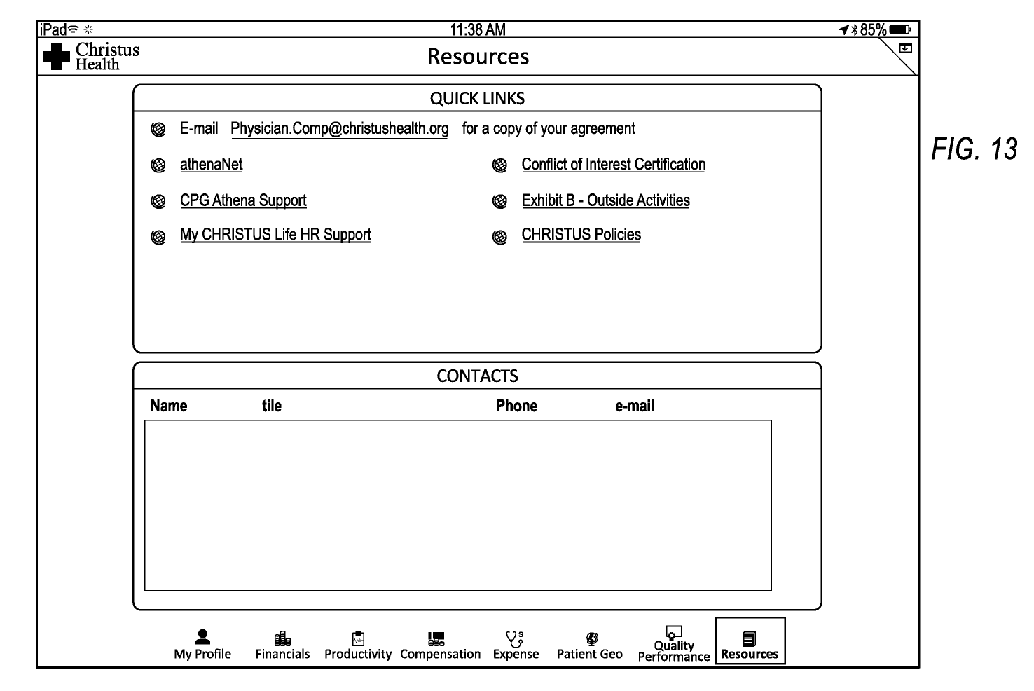

As shown in FIG. 13, each physician may access key contacts and links related to practice management, human resources, policies, and the like from one convenient page.

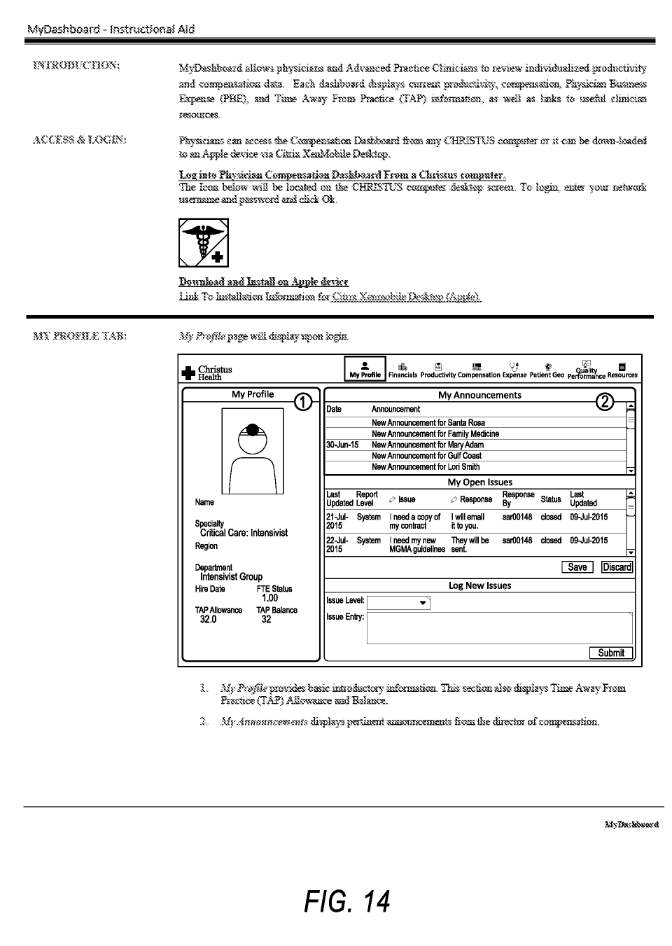

Aspects of some embodiments of the “MyDashboard” application are also described in relation to FIGS. 14-19, which show parts of an instructional aid designed to teach users about the “MyDashboard” application. As shown in FIG. 14, physicians and Advanced Practice Clinicians may review individualized productivity and compensation data. Dashboards may, for example, display current productivity, compensation, Physician Business Expense (PBE), and Time Away From Practice (TAP) information, as well as links to useful clinician resources. In some embodiments, physicians may access a Compensation Dashboard from a hospital computer or the dashboard may be down-loaded to another device. For example, in some embodiments, the dashboard may be down-loaded to an Apple device via Citrix XenMobile Desktop.

As also shown in FIG. 14, a profile page may be displayed upon login. The profile page may provide information including, for example, a Time Away From Practice (TAP) Allowance and Balance. Pertinent announcements may also be displayed. For example, the “My Announcements” section in FIG. 14 displays pertinent announcements from a compensation director.

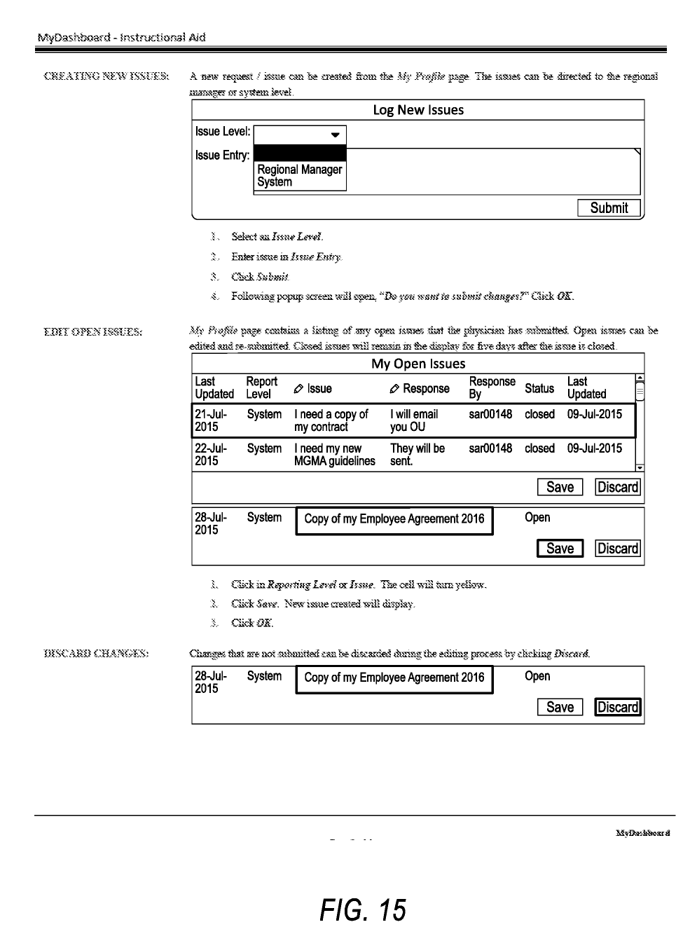

As shown in FIG. 15, requests or issues may also be created from the profile page. For example, requests or issues may be directed to a regional manager or directed to another system level. A user may be able to select an appropriate level for a request or issue using a pull-down menu. The profile page may contain a listing of open issues that a physician has submitted. Open issues may be edited and re-submitted. Closed issues may remain in the display for a suitable period of time, such as for about 5 days after the issue is closed. When editing issues, changes that may not be submitted may be discarded.

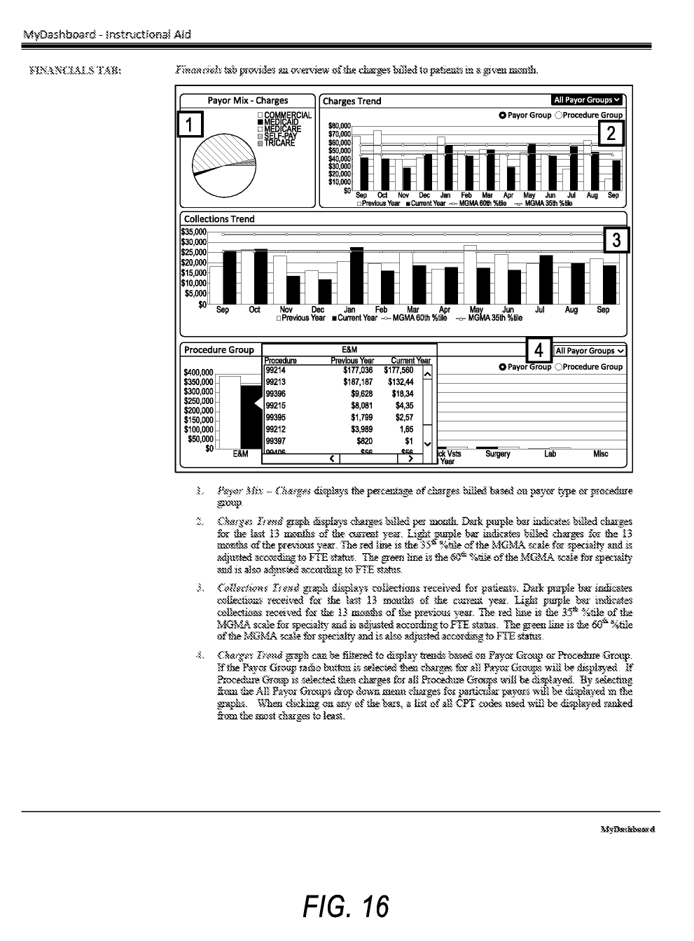

As shown in FIG. 16, a financials tab may provide an overview of charges billed to patients in a given month or over another suitable time period. In some embodiments, a financials tab may include any of a payor mix charges display or graph, charges trend graph, collections trend graph, and combinations thereof.

A payor mix charges graph may, for example, display a percentage of charges billed based on a payor type or a procedure group.

A charges trend graph may display charges billed per month. For example, in the charges trend graph shown in FIG. 16, solid bars may indicate billed charges for the last 13 months including data in the current year. Non-solid bars may indicate billed charges for a 13 month period including a previous year's data. The line with triangular markers in the charges trend graph shown in FIG. 16 is the 35^{th}%tile of the MGMA scale for specialty and is adjusted according to FTE Status. The line with circular markers in the charges trend graph is the 60^{th}%tile of the MGMA scale for specialty and is also adjusted according to FTE status. Of course, bars and marking lines in this and other graphs may also be displayed in a color code or in another suitable way suitable to communicate information to a user. For example, in one embodiment of the “MyDashboard” application the 60^{th}%tile of the MGMA scale for specialty may be displayed as a green line and the 35^{th}%tile of the MGMA scale for specialty may be displayed as a red line.

A collections trend graph may display collections received for patients. For example, in the collections trend graph shown in FIG. 16, solid bars may indicate collections received for the last 13 months including data in the current year. Non-solid bars may indicate collections received for a 13 month period including a previous year's data. The line with triangular markers in the collections trend graph is the 35^{th}%tile of the MGMA scale for specialty and is adjusted according to FTE Status. The line with circular markers in the collections trend graph is the 60^{th}%tile of the MGMA scale for specialty and is also adjusted according to FTE status.

In some embodiments, a charges trend graph may be filtered to display trends based on Payor Group or Procedure Group. For example, if the Payor Group radio button is selected, then charges for all or some other number of Payor Groups may be displayed. If Procedure Group is selected, then charges for all or some other number Procedure Groups may be displayed. By selecting from an All Payor Groups drop down menu, charges for particular payors may be graphically displayed. Clicking on any of the bars may provide a display of a list of CPT codes used. For example, the CPT codes may be displayed and ranked from the most charges to the least or in some other suitable manner.

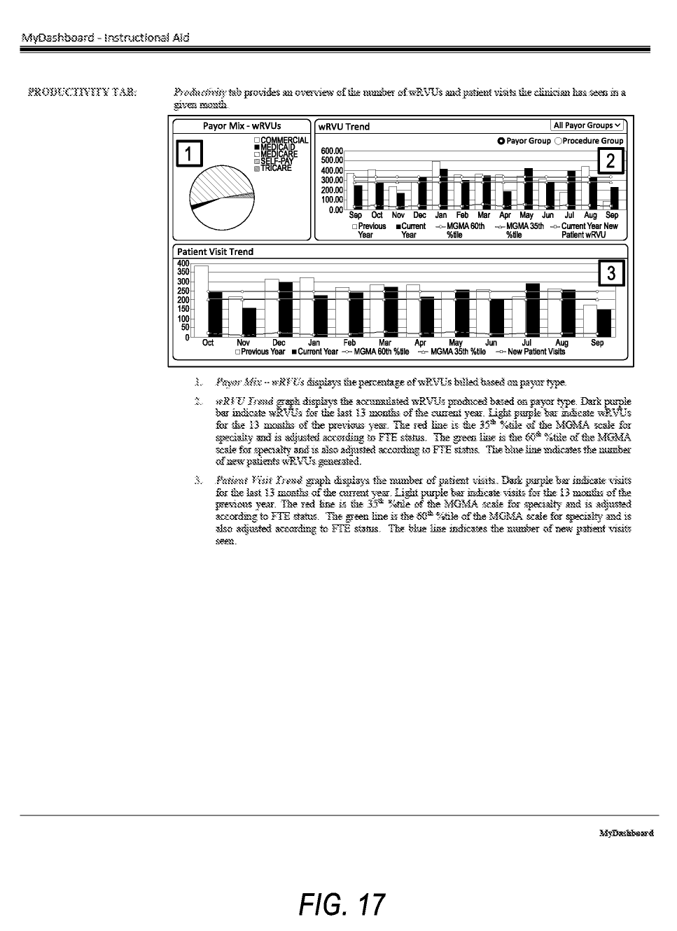

As shown in FIG. 17, a productivity tab may provide an overview of a number of wRVUs and patient visits a clinician has seen in a certain period, such as in a given month. For example, a productivity tab may include a payor mix-wRVUs display or graph, a wRVU trend graph, a patient visit trend graph, and combinations thereof.

A payor mix-wRVUs display or graph may include a percentage of wRVUs billed based on payor type.

A wRVU trend graph may display accumulated wRVUs produced based on payor type. For example, in the wRVU trend graph shown in FIG. 17, solid bars may indicate wRVUs for the last 13 months including data in the current year. Non-solid bars may indicate wRVUs for a 13 months period including data in the previous year. The line with triangular markers in the wRVU trend graph is the 35^{th}%tile of the MGMA scale for specialty and is adjusted according to FTE Status. The line with circular markers in the wRVU trend graph is the 60^{th}%tile of the MGMA scale for specialty and is also adjusted according to FTE status. In addition, the line with square markers may indicate a number of new patients wRVUs generated.

A patient visit trend graph may display a number of patient visits. For example, in the patient visit trend graph shown in FIG. 17, solid bars may indicate visits for the last 13 months including data in the current year. Non-solid bars may indicate visits for a 13 months period including data in the previous year. The line with triangular markers in the patient visit trend graph is the 35^{th}%tile of the MGMA scale for specialty and is adjusted according to FTE Status. The line with circular markers in the patient visit trend graph is the 60^{th}%tile of the MGMA scale for specialty and is also adjusted according to FTE status. In addition, the line with square markers may indicate a number of new patient visits seen.

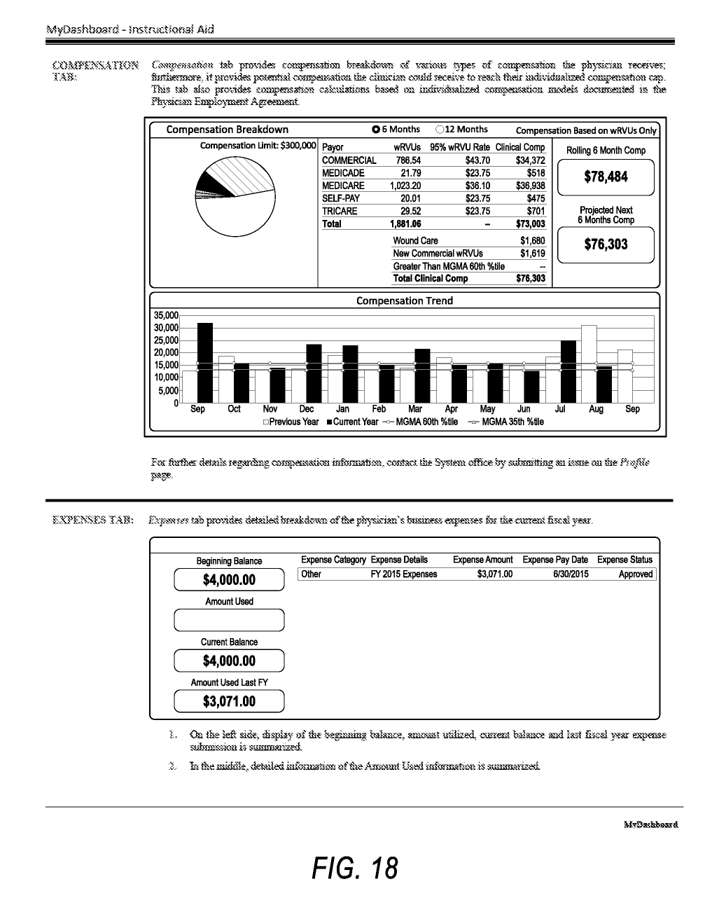

As shown in FIG. 18, a compensations tab may provide a compensation breakdown of various types of compensation a physician receives; furthermore, it provides potential compensation the clinician could receive to reach their individualized compensation cap. The compensation tab may also provide compensation calculations based on individualized compensation models documented in a physician employment agreement.

As also shown in FIG. 18, an expenses tab may provide a detailed breakdown of a physician's business expenses for a fiscal year, such as the current fiscal year. For example, a display may include a summary of a beginning balance, amount utilized, current balance and last fiscal year expense submission. Detailed information of an amount used may also be displayed.

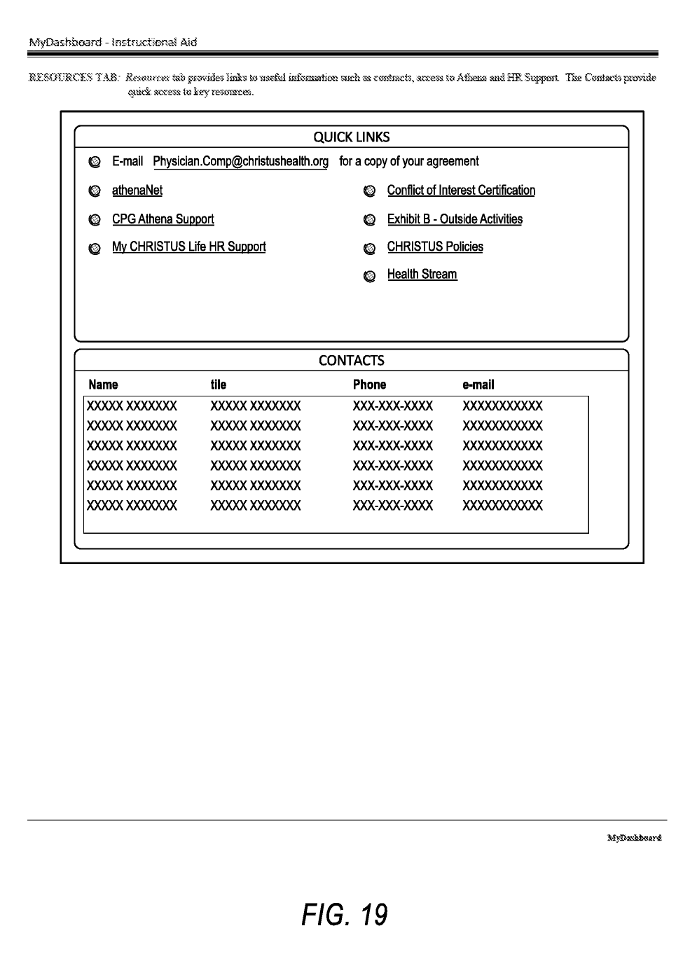

As shown in FIG. 19, a resources tab may provide links to useful information such as contracts, access to HR support or other links such as Athena. Contacts may be provided as a quick access to key resources.

The embodiments described herein are some examples of the current invention. Various modifications and changes of the current invention will be apparent to persons of ordinary skill in the art. Among other things, any feature described for one embodiment may be used in any other embodiment. The scope of the invention is defined by the attached claims and other claims to be drawn to this invention, considering the doctrine of equivalents, and is not limited to the specific examples described herein.

What is claimed is:

1. A tangible computer readable medium comprising instructions executable by a computer for performing the following on a real-time basis via a single application at a client computer:
accessing a database maintained by a health care administration using a communication portal;
displaying a personal profile of a physician;
sending and receiving communications between said physician and said health care administration using said communication portal;
wherein said physician is a member of a group of physicians managed by said health care administration;
wherein said personal profile of said physician is a profile among a plurality of profiles for other physicians included in said group of physicians;
displaying geographic locations of said physician's patients and information regarding inbound referring partners among said other physicians and information regarding outbound referral patterns from said physician to facilitate determination of continuity of care for said physician's patients;
displaying quality metrics and patient satisfaction performance data for said physician against other similar physicians;
receiving daily productivity updates for said physician through said communication portal;
displaying financial charges and collections associated with work performed by said physician during a specified period of time; and
displaying historical, current, and projected compensation for said physician based on said daily productivity updates.

2. The tangible computer readable medium of claim 1 further comprising instructions for:
displaying data representative of time away from practice for said physician.

3. The tangible computer readable medium of claim 1 further comprising instructions for:
displaying personal business expenses data for said physician; and
wherein said personal business expenses data includes a beginning balance, an amount used, a current balance, and an amount used last fiscal year.

4. The tangible computer readable medium of claim 1 wherein said financial charges are displayed by payor type, procedure group, or both.

5. The tangible computer readable medium of claim 1 wherein said daily productivity updates are provided automatically without said physician having to run a query.

6. The tangible computer readable medium of claim 1 further comprising instructions for:
displaying benchmarks for each of said financial charges and said collections associated with work performed by said physician and information to compare said financial charges and said collections associated with work performed by said physician to financial charges and collections data for like-specialists on a national or other regional level.

7. The tangible computer readable medium of claim 1 further comprising instructions for:
displaying charge-lag, no-show rates, slot times, and clinic schedules for said physician.

8. The tangible computer readable medium of claim 1 further comprising instructions for:
organizing said communications based on whether said communications are related to an open or a closed issue.

9. The tangible computer readable medium of claim 1 wherein said productivity updates include wRVUs and patient visits for said physician.

10. The tangible computer readable medium of claim 1 wherein said productivity updates include wRVUs generated for said physician in each of a payor category and a procedure category.

11. The tangible computer readable medium of claim 1 further comprising instructions for:
displaying wRVUs for said physician and patient visits for said physician for a selected time period simultaneously on one display screen; and
displaying benchmark information on said display screen to compare said wRVUs for said physician and said patient visits for said physician to wRVUs and patient data for like-specialists.

12. The tangible computer readable medium of claim 1 further comprising instructions for:
displaying either of said quality metrics for said physician or said patient satisfaction performance data for said physician on a display screen and simultaneously displaying either of regional quality metrics or regional patient satisfaction performance data on said display screen.

13. A healthcare communication system comprising:
a database maintained by a health care administrator;
wherein said database includes a repository of data pertaining to a plurality of practices for a plurality of physicians and patients of said plurality of physicians;
a computer in communication with said database, said computer programmed to communicate with a plurality of computers through a communication portal and provide information to said plurality of computers to allow each of said plurality of computers to perform the following on a real-time basis:
displaying a personal profile of a physician included among said plurality of physicians;
sending and receiving communications between said physician and said health care administration using said communication portal;
displaying geographic locations of said physician's patients and information regarding inbound referring partners included among said plurality of physicians and information regarding outbound referral patterns from said physician to facilitate determination of continuity of care for said physician's patients;
displaying quality metrics and patient satisfaction performance data for said physician against other similar physicians;
receiving daily productivity updates for said physician through said communication portal;
displaying financial charges and collections associated with work performed by said physician during a specified period of time; and
displaying historical, current, and projected compensation for said physician based on said daily productivity updates.

14. The health care communication system of claim 13 wherein said computer further provides information to said plurality of computers to allow each of said plurality of computers to perform the following:
displaying personal business expenses data for said physician; and
wherein said personal business expenses data includes a beginning balance, an amount used, a current balance, and an amount used last fiscal year.

15. The health care communication system of claim 13 wherein said financial charges are displayed by payor type, procedure group, or both.

16. The health care communication system of claim 13 wherein said daily productivity updates are provided automatically without said physician having to run a query.

17. The health care communication system of claim 13 wherein said computer further provides information to said plurality of computers to allow each of said plurality of computers to perform the following:
displaying benchmarks for each of said financial charges and said collections associated with work performed by said physician and information to compare said financial charges and said collections associated with work performed by said physician to financial charges and collections data for like-specialists on a national or other regional level.

18. The health care communication system of claim 13 wherein said computer further provides information to said plurality of computers to allow each of said plurality of computers to perform the following:
displaying charge-lag, no-show rates, slot times, and clinic schedules for said physician.

19. The health care communication system of claim 13 wherein said computer further provides information to said plurality of computers to allow each of said plurality of computers to perform the following:
displaying wRVUs for said physician and patient visits for said physician for a selected time period simultaneously on one display screen; and
displaying benchmark information on said display screen to compare said wRVUs for said physician and said patient visits for said physician to wRVUs and patient data for like-specialists.

20. The health care communication system of claim 13 wherein said computer further provides information to said plurality of computers to allow each of said plurality of computers to perform the following:
displaying either of said quality metrics for said physician or said patient satisfaction performance data for said physician on a display screen and simultaneously displaying either of regional quality metrics or regional patient satisfaction performance data on said display screen.
